(19) United States
(12) Patent Application Publication
(10) Pub. No.: US 2002/0163661 A1
(43) Pub. Date: Nov. 7, 2002

(54) Providing user-accessible information from a consumable

(76) Inventor: Rigby Jacobs Heusinkveld, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/848,634

(22) Filed: May 3, 2001

(51) Int. Cl. B41F 1/00; G06F 15/00

(52) U.S. Cl. 358/1.14; 358/1.15

(57) ABSTRACT

A consumable for a device in communication with a host device comprising of a housing, a nonvolatile memory wherein consumable-related information is originally stored, and a communication interface for facilitating communication wherein the host device accesses consumable-related information through the device.

### RELATED APPLICATIONS

The present application is related to commonly assigned, co-pending U.S. patent application Ser. No. [Attorney Docket No. 10007179-1], entitled, “PROVIDING AUTOMATED WARRANTY FULFILLMENT FUNCTIONALITY FROM A CONSUMABLE;” U.S. patent application Ser. No. 09/480,545, entitled, “REDUNDANT REORDER PREVENTION FOR REPLACEABLE PRINTER COMPONENTS,” filed Jan. 10, 2000, which is a continuation in part of co-pending U.S. patent application Ser. No. 09/410,989, entitled, “METHOD AND APPARATUS FOR IDENTIFYING A SALES CHANNEL,” filed Oct. 1, 1999, the disclosures of which are hereby incorporated herein by reference.

### TECHNICAL FIELD

This invention generally relates to image forming and office automation devices, and more particularly to self-managing consumables for use in these devices which include a memory storing useful information regarding the consumable stored during the consumable manufacturing or recycling process.

### BACKGROUND

Image forming and office automation devices, such as facsimile machines, printers, copiers, and scanners, use any number of consumables, e.g., toner, ink, ribbon, photoconductor, developer, and the like. These image forming materials are provided in the consumables in finite quantities and are, therefore, typically replaced at the end of their respective useful lives. Many of the consumables also contain any number of chemicals which generally make up the image forming capability. Ink, for example, may comprise any number of different chemicals depending on the color, the opacity, and/or the expected lifespan of the inked image. Knowledge of the specific chemicals used in such consumables may be important for purposes of poison control, contamination and/or spill, allergy-toxicity issues, and even in the event of a fire.

Companies manufacturing such products containing different chemicals typically make documentation available for public access that discloses the products' health and safety characteristics. These types of documents can generally list the chemical contents in the products. However, the exact chemical composition or chemical make-up may often be proprietary or protected as a trade secret. Thus, companies generally tend to disclose only the essential health and safety characteristics. These documents are usually called material safety data sheets (MSDS). MSDSs are standardized to describe the health and safety characteristics of the material or chemical content of any item, such as a toner cartridge, photoconductor, or other image forming consumable, as well as for general purpose items such as paints or insulating material. Because the regulatory agencies do not currently require image processing consumables to include such data in their packaging, MSDSs are typically provided on a publicly accessible website or through some type of fax or mail service from the company.

A user desiring to know the health and safety characteristics of the chemical or material content of a consumable may download an MSDS from the website, such as www.hp.com, or call the company to receive one. The existing process for making such information available to users pre-supposes that a user will have ready access to the Internet, phone, or fax. This may not always be true. Users who do not have such access may not be able to easily obtain this safety information. Depending on the environmental sensitivity of such an individual, exposure to certain commercially available chemicals or materials may cause life-threatening consequences. Furthermore, in poisoning situations, timely access to such information is generally paramount to successfully counter-acting the ingested potentially poisonous chemicals.

The use of consumables in image forming and office automation devices sometimes also creates problems or failures in the operation of the devices, themselves. A competent user manual for such image forming and office automation devices may generally address problems that may be encountered with a consumable. It may also provide instructions or troubleshooting tips to assist the user in overcoming such problems. However, in some environments, device operating manuals are not kept by the device. In other circumstances, users may inadvertently or carelessly throw the manual away. In still other cases, an inadequately written user manual may not even address problems or failures that may be caused by a consumable. Such an omission or lack of information may cause a user to dispose of a consumable before it is necessary to do so. More critical to the consumable company, the user may take the consumable back under a warranty condition. Because it may not be possible to determine the problem by physically observing the consumable, the company may end up refunding or exchanging one working consumable for another thereby costing the consumable company at least the cost of another consumable.

Consumable manufacturers have begun to design intelligence into the consumable itself, which can then interact with the host system. In some consumables, consumable management electronics have been incorporated directly into the consumable. One such technology is described in commonly assigned, U.S. Pat. No. 5,930,553, entitled, “Image Forming and Office Automation Device Consumable with Memory,” the disclosure of which is hereby incorporated herein by reference. Consumables configured according to this technology incorporate nonvolatile memory which can generally store use information retrieved from the host system, such as a host computer connected to a printer or a fax machine. This information can generally be retrieved when the consumable is taken to a recycling center. The information retrieved from the system allows consumable manufacturers to learn about the use and performance of the consumable in order to improve the useful life and quality of future consumables. It also provides the ability for software updates to be stored on the consumable. The controlling software and drivers of the device or host system generally allows the consumable to update the existing drivers or control software.

However, current consumables do not specifically provide consumable-disposed memory for allowing a user access to pre-stored consumable-oriented information.

### SUMMARY OF THE INVENTION

A consumable for a device in communication with a host device comprising of a housing, a nonvolatile memory wherein consumable-related information is originally stored, and a communication interface for facilitating communication wherein the host device accesses consumable-related information through the device.

### BRIEF DESCRIPTION OF THE DRAWING

FIG. 1 is a diagram illustrating a consumable configured according to a preferred embodiment of the present invention;

FIG. 2 is a diagram illustrating an alternative preferred embodiment of the present invention configured with a host general purpose computer;

FIG. 3 is a diagram illustrating another alternative preferred embodiment of the present invention configured with a self-contained image forming device/host system; and

FIG. 4 is a flow chart illustrating the steps according to the preferred method of the present invention.

### DETAILED DESCRIPTION

The present invention is directed to a system and method for providing user-accessible information relating to a consumable on the consumable itself. A consumable configured according to a preferred embodiment of the present invention will preferably incorporate nonvolatile memory in order to store consumable-related information preferably stored by the manufacturer or recycler. When the user inserts the consumable into the image forming or office automation device, a connection is preferably made between an interface of the consumable and the device. This communication interface preferably allows for information to be exchanged between the device and the consumable. The device may itself be operably connected to a host system, such as when a printer is connected to a general purpose computer, or it may be a single, self-contained device/host system, such as with a facsimile machine or copier. The communication interface preferably allows the user to obtain the stored information either through a separate system, such as a computer, or the device/system itself, such as through a facsimile machine.

In operation, when the user desires to access the stored information, he or she will preferably be able to select an option through a host computer or the image forming device for retrieving the information. The selection will then preferably cause the consumable-related data to be transmitted over the communication interface for presentation to the user.

Existing consumables typically do not incorporate any types of useful information relating to the actual consumable. Intelligence is beginning to be designed into consumables, as previously mentioned with regard to U.S. Pat. No. 5,930,553. Additional advancements in consumable intelligence have also been included in the aforementioned commonly-assigned, co-pending U.S. application Ser. No. 09/480,545, entitled, “REDUNDANT REORDER PREVENTION FOR REPLACEABLE PRINTER COMPONENTS,” the disclosure of which is hereby incorporated herein by reference. In this co-pending application, the consumable automatically reorders a new consumable when it reaches a certain level. The automated system according to the application includes a reorder prevention system that prevents another consumable from being reordered if the levels in the current consumable are “increased,” such as by shaking a toner cartridge.

Additionally, in the aforementioned, concurrently-filed, commonly-assigned, copending U.S. patent application Ser. No. [Attorney Docket No. 10007179-1], entitled “PROVIDING AUTOMATED WARRANTY FULFILLMENT FUNCTIONALITY FROM A CONSUMABLE,” the disclosure of which is hereby incorporated herein by reference, a consumable is disclosed which incorporates nonvolatile memory and management processing capabilities to automatically assist a user with obtaining and completing warranty information.

FIG. 1 illustrates a generic consumable configured according to a preferred embodiment of the present invention. Consumable 10 may be a toner cartridge, an ink cartridge, a developer, or the like. In its basic form, consumable 10 preferably comprises housing 100, image forming material 101 contained within housing 100, nonvolatile memory 102, and communication interface 103. Consumable 10 also includes on-board consumable management processor 104, which may perform diagnostic tests on consumable 10 and also provides higher level communication functionality with a connected image forming system or office automation device. It should be noted that the present invention is not limited to consumables containing processing functionality such as with consumable management processor 104.

During the manufacturing or recycling process, the manufacturer or recycler preferably stores consumable-oriented information 105 onto nonvolatile memory 102. For example, as shown in FIG. 1, consumable-oriented information 105 may comprise such information as MSDS 105-1, Troubleshooting Tips 105-N, and any other information useful to the administration of consumable 10.

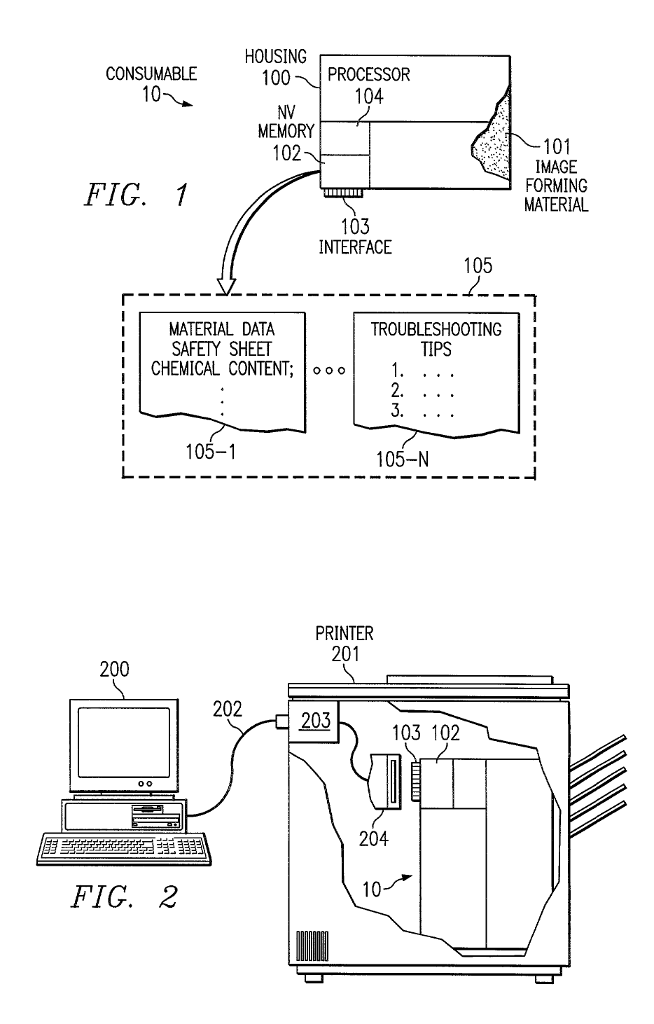

FIG. 2 illustrates the inventive consumable, consumable 10 in place in printer 201 (printer 201 is a partial cut-away illustration of a printer). Printer 201 is connected to computer 200 via printer cable 202. Communication interface 103 connects with consumable connector 204. This connection allows communication between print processor 203 of printer 201 and consumable 10. When a user at computer 200 desires to access the consumable-related information preferably stored on nonvolatile memory 102, software within the printer driver on computer 200 allows the user to access nonvolatile memory 102. The user will preferably be provided a list of available information and allowed to select the desired information. In one embodiment, the user is preferably offered a choice of either to view the information on the display of computer 200 or to print a hard copy from printer 200. When the user selects to view the information, the information preferably stored on nonvolatile memory 102 is preferably transmitted over communication interface 103 to print processor 203 through consumable connector 204. The selected information is then preferably further transmitted to the host device, i.e., computer 200, for display to the user.

If the user chooses instead to print a hard copy of the selected information, the information preferably stored on nonvolatile memory 102 is preferably transmitted over communication interface 103 to print processor 203 through consumable connector 204. Once the information has been communicated to print processor 203, the information may preferably be printed without first being transmitted to computer 200.

In an alternative embodiment of the present invention, the user may only be offered the opportunity to directly print the selected information stored on nonvolatile memory 102. When the user selects the particular information, it is preferably printed from printer 201 according to the process described in the previous paragraph.

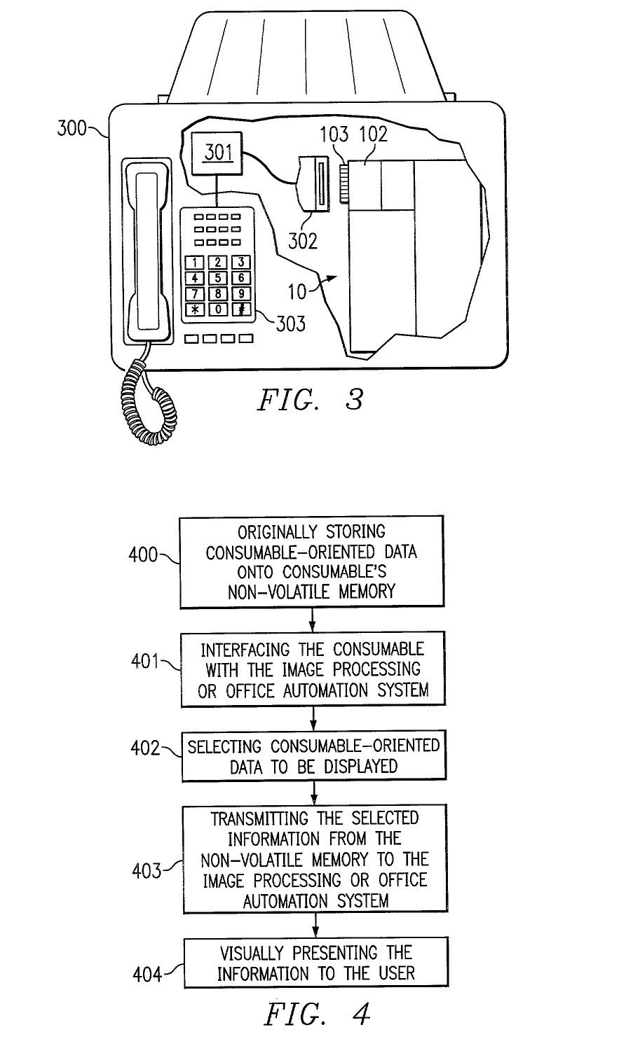

FIG. 3 illustrates a further alternative embodiment of the present invention. Instead of a toner or ink cartridge for a printer, consumable 10 of FIG. 3 is a toner cartridge or developer for facsimile 300 (facsimile 300 is a partial cut-away illustration of a facsimile machine). When consumable 10 is inserted into facsimile 300, communication interface 103 preferably forms an electrical connection with consumable connector 302. Fax control software on fax processor 301 facilitates communication with nonvolatile memory 102 and also provides the control instructions for facsimile 300. Fax processor 301 executes the fax control software and provides the controlling electronics. If a user desires to obtain information regarding consumable 10 preferably stored on nonvolatile memory 102, he or she may preferably select the information by using a key-punch sequence on keypad 303.

Once the user has selected the desired information, the information is preferably transmitted from nonvolatile memory 102 to fax processor 301 through communication interface 103 and consumable connector 302. Because of the typically limited display mechanism on a facsimile machine, the preferred embodiment may only provide for a direct printing of the information from facsimile 300. Fax processor 301 would then preferably execute the fax control software to preferably print the selected consumable-oriented information stored on nonvolatile memory 102.

An alternative embodiment may preferably provide the user a choice of viewing the information on facsimile 300's display (not shown). In such an embodiment, the controlling fax control software would provide scrolling instructions for the user to have the ability to preferably scroll back and forth through the selected information.

It will be appreciated that as the inventive consumable is inserted. into an image forming device, such as printer 201 (FIG. 2) or facsimile 300 (FIG. 3), the technology disclosed in the aforementioned commonly assigned U.S. Pat. No. 5,930,553, entitled “Image Forming and Office Automation Device Consumable with Memory,” the disclosure of which is hereby incorporated herein by reference, may be utilized to update the printer driver or fax control software to allow access to the consumable-related information preferably stored on the nonvolatile memory. Thus, even devices manufactured prior to the implementation of the inventive method may take advantage of the novel technology described herein.

It should be noted that the present invention is not limited to application solely on printers and facsimile machines, as described above. Alternative embodiments of the present invention may be used on any variety of image forming or office automation equipment.

FIG. 4 presents a flowchart of the steps used to implement a preferred embodiment of the present invention. In the first step, step 400, the consumable-oriented data is downloaded and stored onto the image processing consumable's nonvolatile memory. Step 400 occurs prior to the consumable being placed or replaced into the stream of commerce (i.e., the manufacturer or recycler stores the consumable-related information on the consumable's memory). Once the consumable is purchased, the consumable is interfaced with the image processing or office automation system in step 401. At step 402, the user selects from a list of available data, the desired data he or she wishes to view. Once the user selects the desired data, the data is transmitted from the memory to the image processing or office automation system in step 403. The transmitted data will then be visually presented to the user at step 404 either by providing it to a graphical electronic display, such as a computer monitor or light emitting diode (LED) panel, or by making a hard copy of the data, such as through a printer, facsimile, or copier.

What is claimed is:

1. A consumable for a device in communication with a host device, said consumable comprising:
a housing;
a nonvolatile memory;
consumable-related information originally stored on said nonvolatile memory; and
a communication interface for facilitating communication with said device, wherein said host device accesses said consumable-related information through said device.

2. The consumable of claim 1 wherein said device is an image forming device and includes image forming material contained in said housing for use in forming images.

3. The consumable of claim 1 wherein said device and said host device are configured as a single system.

4. The consumable of claim 1 wherein said host device is a discrete device operably connectable to said device.

5. The consumable of claim 4 wherein said host device comprises a general purpose computer.

6. A method for providing consumable-related data to a user of an office automation system comprising the steps of:
storing said consumable-related data onto a memory disposed on a consumable;
interfacing said consumable with said office automation system;
selecting said consumable-related data;
transmitting said selected consumable-related data to said office automation system; and
presenting said transmitted consumable-related data to said user.

7. The method of claim 6 further comprising the step of:
communicating said transmitted consumable-related data to a host system, wherein said presenting step is conducted on said host system.

8. The method of claim 7 wherein said host system comprises a general purpose computer.

9. The method of claim 6 wherein said presenting step comprises the step of:
displaying said transmitted consumable-related data on a computer display.

10. The method of claim 6 wherein said presenting step comprises the step of:
printing said transmitted consumable-related data.

11. A processing system comprising:
means for controlling functions of said processing system;
means for originally storing consumable-oriented information on a consumable of said processing system;
means for selecting portions of said consumable-oriented information;
means for communicating said consumable-oriented information from said consumable to said means for controlling; and
means for providing said selected portions of said consumable-oriented information to a user.

12. The system of claim 11 wherein said means for communicating include:
means for interfacing said consumable with said processing system.

13. The system of claim 11 wherein said means for providing comprises a video monitor.

14. The system of claim 11 wherein said means for providing comprise:
means for printing.

15. The system of claim 11 further comprising:
means for coupling a host system to said processing system.

16. The system of claim 15 wherein said host system comprises a general purpose computer.

17. The system of claim 15 wherein said means for providing is operably connected to said host system.
